(19) United States
(12) Patent Application Publication
(10) Pub. No.: US 2012/0008903 A1
(43) Pub. Date: Jan. 12, 2012

(54) OPTICAL TRANSMISSION LINE HOLDING MEMBER AND AN OPTICAL MODULE

(75) Inventors: Kei Obara, Kawasaki-shi (JP); Hiroshi Uemura, Yokohama-shi (JP); Hideto Furuyama, Yokohama-shi (JP)

(73) Assignee: KABUSHIKI KAISHA TOSHIBA, Tokyo (JP)

(21) Appl. No.: 13/177,142

(22) Filed: Jul. 6, 2011

(30) Foreign Application Priority Data
Jul. 6, 2010 (JP) 2010-154274

(51) Int. Cl. G02B 6/36

(52) U.S. Cl. 385/88

(57) ABSTRACT

According to one embodiment, an optical transmission line holding member includes a holding member body, a plurality of holding holes, a plurality of electrical interconnections, and a plurality of grooves. The holding member body includes an optical semiconductor element mounting surface and an opposite surface thereof and configured to hold optical transmission lines. The holding holes are formed to penetrate between the optical semiconductor element mounting surface of the holding member body and the opposite surface thereof, the holding holes having an opening on the optical semiconductor element mounting surface side. The electrical interconnections are provided on a part of the optical semiconductor element mounting surface and electrically connected to the optical semiconductor element. The grooves are provided adjacent to the openings of the holding holes in a part of a region of the optical semiconductor element mounting surface except a region in which the electrical interconnections.

### CROSS-REFERENCE TO RELATED APPLICATIONS

This application is based upon and claims the benefit of priority from prior Japanese Patent Application No. 2010-154274, filed Jul. 6, 2010, the entire contents of which are incorporated herein by reference.

### FIELD

Embodiments described herein relate generally to an optical transmission line holding member and an optical module.

### BACKGROUND

Recently, in signal transmission between electronic devices and in the electronic device, much attention is paid to signal transmission (optical signal transmission) utilizing light as the technique for realizing high operation speed and low noise. As one optical coupling device (optical module) used for optical signal transmission, an optical module that uses an optical transmission line holding member and can directly and optically couple an optical semiconductor element such as a light-emitting element or light-receiving element with an optical transmission line such as an optical fiber without using an optical component such as a lens is proposed.

### BRIEF DESCRIPTION OF THE DRAWINGS

FIGS. 1A and 1B are perspective and cross-sectional views showing the schematic structure of an optical transmission line holding member according to a first embodiment.

FIGS. 2A and 2B are cross-sectional views for illustrating a flow-out process of an optical coupling material in a holding hole of the optical transmission line holding member of the first embodiment.

FIGS. 3, 4A and 4B are perspective views showing modifications of the optical transmission line holding member of the first embodiment.

FIGS. 5A and 5B are perspective and cross-sectional views showing the schematic structure of an optical transmission line holding member according to a second embodiment.

FIG. 6 is a cross-sectional view for illustrating a flow-out process of an optical coupling material in a holding hole of the optical transmission line holding member of the second embodiment.

FIGS. 7A and 7B are perspective views showing modifications of the optical transmission line holding member of the second embodiment.

FIGS. 8A and 8B are a perspective and cross-sectional views showing the schematic structure of an optical module according to a third embodiment.

FIGS. 9A, 9B and 9C are cross-sectional views for illustrating a manufacturing method of the optical module according to the third embodiment.

### DETAILED DESCRIPTION

In general, according to one embodiment, an optical transmission line holding member includes a holding member body, a plurality of holding holes, a plurality of electrical interconnections, and a plurality of grooves. The holding member body includes an optical semiconductor element mounting surface and an opposite surface thereof and configured to hold optical transmission lines. The holding holes are formed to penetrate between the optical semiconductor element mounting surface of the holding member body and the opposite surface thereof, the holding holes having an opening on the optical semiconductor element mounting surface side. The electrical interconnections are provided on a part of the optical semiconductor element mounting surface and electrically connected to the optical semiconductor element. The grooves are provided adjacent to the openings of the holding holes in a part of a region of the optical semiconductor element mounting surface except a region in which the electrical interconnections.

(First Embodiment)

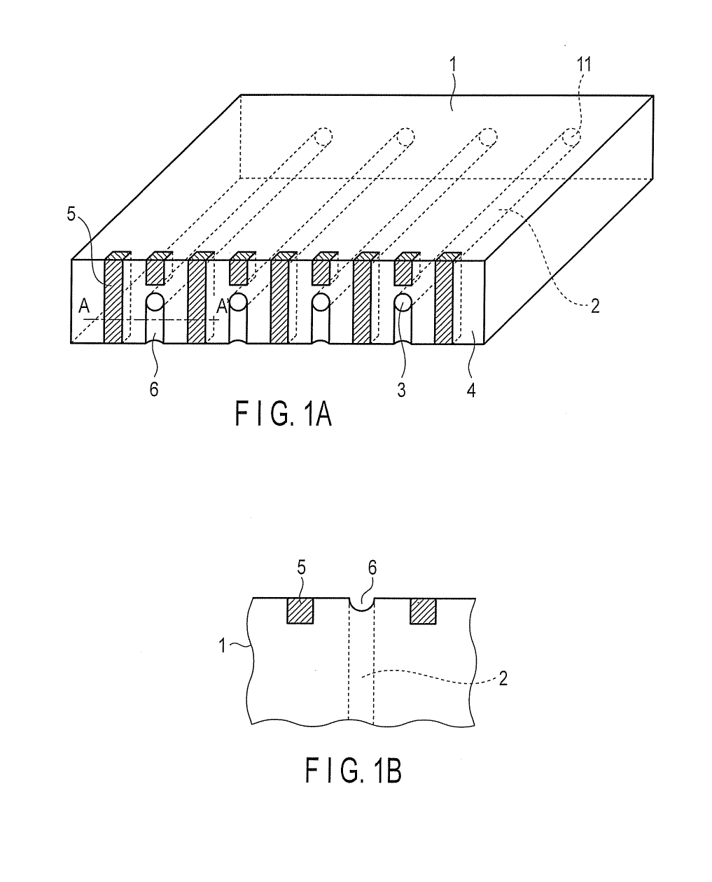

FIG. 1A is a perspective view of the optical transmission line holding member as viewed from the optical semiconductor element mounting surface side and

FIG. 1B is a cross-sectional view taken along line A-A′ of FIG. 1A.

In FIGS. 1A and 1B, 1 denotes a holding member body, 2 holding holes that hold optical transmission lines, 3 one-side openings of the holding holes 2, 4 an optical semiconductor element mounting surface, 5 electrical interconnections, 6 grooves and 11 the other-side openings of the holding holes 2.

In the holding member body 1, the holding holes 2 penetrating therethrough between the optical semiconductor element mounting surface 4 and the surface opposite thereto to hold optical transmission lines such as optical fibers, for example, are provided. The electrical interconnections 5 used for electrical connection with the optical semiconductor element 8 are formed on the optical semiconductor element mounting surface 4 of the holding member body 1. The one-side openings 3 of the holding holes 2 and the electrical interconnections 5 are provided on the optical semiconductor element mounting surface 4 and the grooves 6 used as flow passages of optical coupling materials used for optically coupling the optical semiconductor element 8 with the optical transmission lines are further formed in the optical semiconductor element mounting surface 4.

For example, the holding member body 1 is formed of a material having a filler such as silicon oxide or alumina, for example, filled in resin such as epoxy resin, polyphenylene sulfide (PPS) resin or polybutylene terephthalate (PBT) resin. In FIG. 1A, the dimensions of the holding member body 1 are set to the width of 4.4 mm, the depth of 4.5 mm and the height of 1.0 mm, for example.

For example, the holding member body 1 is formed by injection-molding of the above resin by using a metal mold. In FIG. 1A, the outer shape of the holding member body 1 is shown in a rectangular form, but this can be processed in a desired form. Further, when an optical module in which an optical semiconductor element and optical transmission lines are optically coupled with each other is formed, the light-receiving surface of the optical semiconductor element and the end face of the optical transmission lines are set in parallel if the optical semiconductor element mounting surface 4 of the holding member body 1 is set perpendicular to the holding holes 2. Therefore, return optical noise tends to occur. In order to prevent the above problem, the optical semiconductor element mounting surface 4 of the holding member body 1 may be formed with a preset angle (for example, 2° or more) of inclination in the vertical direction as viewed from the viewpoint of FIG. 1A.

The electrical interconnections 5 are formed by embedding lead frames (for example, the width of one lead is 50 μm and the distance from the adjacent lead is 75 μm) formed of, for example, Cu or Cu alloy in the optical semiconductor element mounting surface 4 of the holding member body 1. Further, the surface portions of the electrical interconnections 5 are exposed to the optical semiconductor element mounting surface 4 and the end face portions (for example, 50 μm×50 μm) of the lead frames are exposed to the surface thereof (the side surface of the holding member body 1) that is adjacent to the optical semiconductor element mounting surface 4.

The surface of the electrical interconnection 5 is subjected to a surface process such as a Ni/Au-plating process, for example. Therefore, the optical semiconductor elements can be mounted on the optical semiconductor element mounting surface 4 by use of an ultrasonic flip-chip mounting method, for example. Further, the end face of the lead frame exposed to the side surface of the holding member body 1 can be used as an electrode pad and can be electrically connected to an external electrical interconnection, for example, by wire bonding. The process of embedding the lead frame can be performed by, for example, molding the holding member body 1 while the lead frame is fixed in a mold at the injection-molding time.

The electrical interconnections 5 may be formed by a process of forming 3-dimensional interconnections such as 3-dimensional plating interconnections, for example. Also, in this case, it is of course possible to mount the optical semiconductor element on the optical semiconductor element mounting surface 4 and it is possible to form electrical interconnections 5 continuously extending from the optical semiconductor element mounting surface 4 to the side surface of the holding member body 1 and use the same as electrode pads for electrically connecting the interconnection region formed on the side surface to the exterior. It is needless to say that the technical scope of this embodiment is not limited by the number, shape, interconnection width, interconnection pitch and the like of the electrical interconnections 5.

The holding holes 2 are penetration holes, arranged side by side at preset intervals in the holding member body 1. Each hole has the one-side opening 3 on the optical semiconductor element mounting surface 4 and the other-side opening 11 on the surface opposite to the optical semiconductor element mounting surface 4. For example, it is supposed that the diameter of the holding hole 2 is 125 μm and the pitch with respect to the adjacent holding hole 2 is 250 μm. The other-side opening 11 of the holding hole 2 is used as an insertion port of the optical transmission line and the optical transmission line inserted in the holding hole 2 and the optical semiconductor element mounted on the optical semiconductor element mounting surface 4 are optically coupled on the opening 3 side of the holding hole 2.

In FIG. 1A, the holding hole 2 is formed as a circular penetration hole, but may be formed with a shape different from the circle. Further, in FIG. 1A, the optical transmission holding member having the four holding holes 2 is shown, but the number of holding holes 2 provided in the holding member body 1 can be properly changed as required.

The groove 6 is a concave portion (for example, the width 100 μm and the depth 50 μm) formed between the peripheral portion of the optical semiconductor element mounting surface 4 and the peripheral portion of the opening 3 in the optical semiconductor element mounting surface 4. For example, the grooves 6 can be formed by setting a mold having convex portions on the surface thereof to face the optical semiconductor element mounting surface 4 when the holding member body 1 is molded.

In FIG. 1A, an example in which the groove 6 is linearly formed with one end of the groove 6 connected to the peripheral portion of the opening 3 and the other end of the groove 6 connected to the peripheral portion of the optical semiconductor element mounting surface 4 is shown. However, the groove 6 can be formed with a desired shape if it is formed adjacent to the opening 3. For example, the shape of the groove 6 is not limited to the linear form and can be set to a desired form. The groove 6 may be a groove that completely surrounds the peripheral portion of the opening 3 and may be formed not to reach the peripheral portion of the opening 3 and the peripheral portion of the optical semiconductor element mounting surface 4. Further, the cross section of the concave portion of the groove 6 is not limited to an arc form as shown in FIG. 1B and can be formed with a desired form. Additionally, the number of grooves 6 can be properly changed. Further, it is desirable to provide the grooves 6 for all of the openings 3 of the holding holes 2 as shown in FIG. 1A.

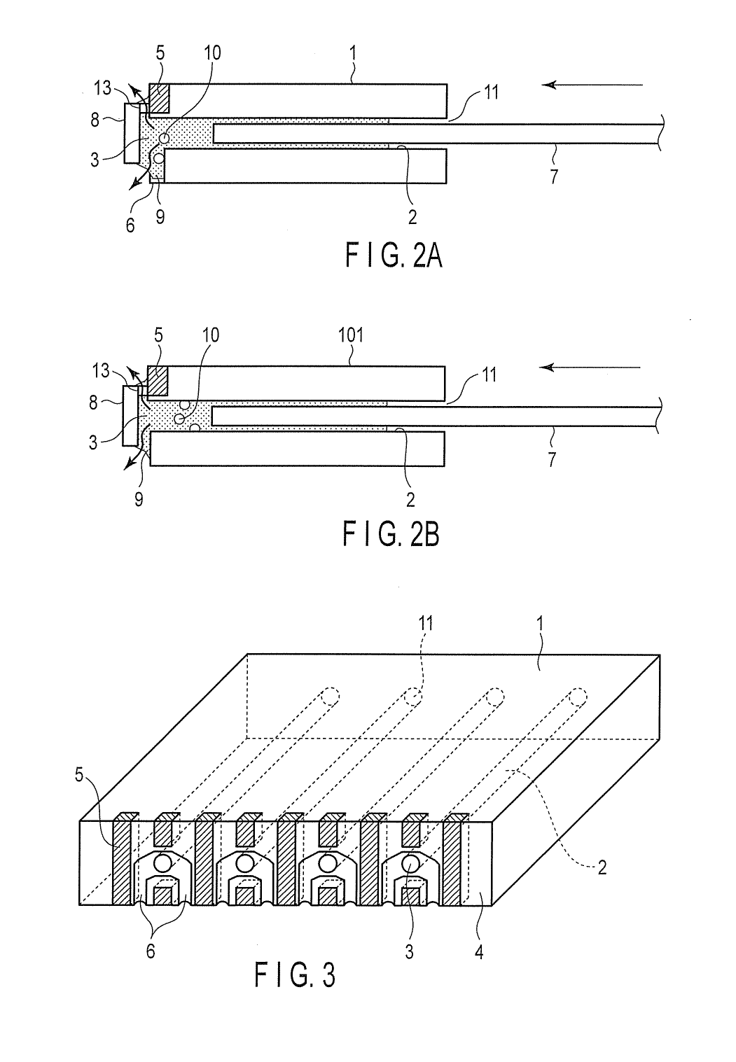

Now, the effect attained by the optical transmission line holding member shown in FIGS. 1A and 1B is explained with reference to FIGS. 2A and 2B. FIGS. 2A and 2B are views for illustrating a flow-out process of an optical coupling material in a process of inserting an optical transmission line together with the optical coupling material 9 into the holding hole 2 of the holding member body 1. FIG. 2A is a cross-sectional view showing the holding member body 1, for illustrating a flow-out process in the optical transmission line holding member of the first embodiment and FIG. 2B is a cross-sectional view showing a holding member body 101, for illustrating a flow-out process in an optical transmission line holding member described in shown as a comparison object. In FIGS. 2A and 2B, portions that are the same as those of FIGS. 1A and 1B are denoted by the same numbers and detailed explanation thereof is omitted.

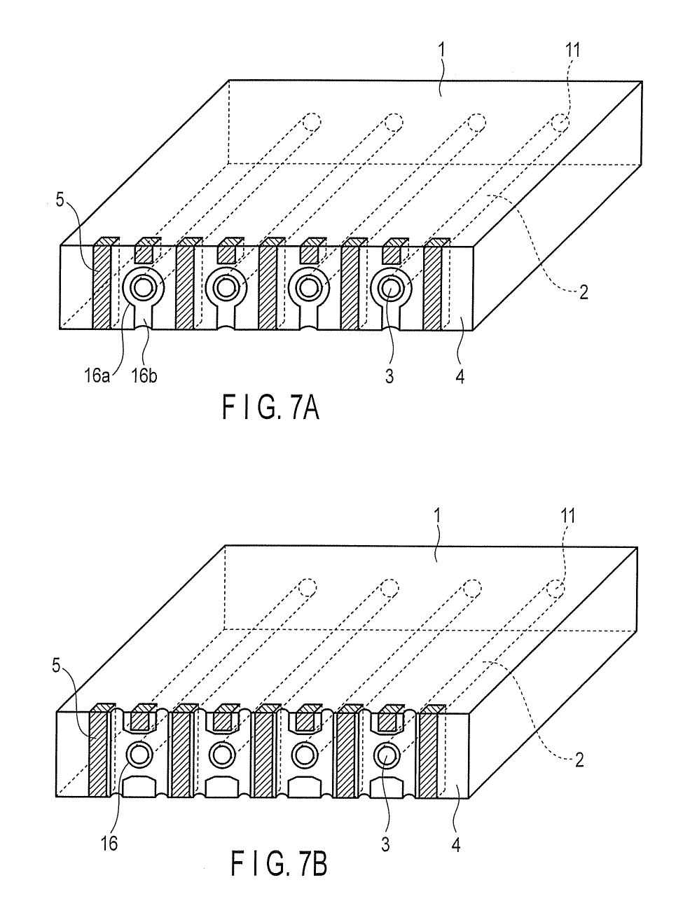

In FIGS. 2A and 2B, 7 denotes an optical transmission line, 8 an optical semiconductor element, 9 an optical coupling material, 10 bubbles provided in the optical coupling material, 13 an Au stud bump and 101 a holding member body having no grooves 6 formed therein.

The optical transmission line 7 is held in the holding hole 2 of the holding member body 1 and optically coupled with the optical semiconductor element 8 that will be described later in a portion near the one-side opening 3 of the holding hole 2. For example, the optical transmission line 7 can be formed of an optical fiber (for example, a graded index [GI] fiber of diameter 125 μm and core diameter 50 μm) using glass or plastic. The optical transmission line 7 may be a single-core line or a ribbon-form bundle obtained by bundling a plurality of optical fibers at equal pitches (for example, 250 μm pitches).

The optical semiconductor element 8 is mounted on the electrical interconnections 5 of the optical semiconductor element mounting surface 4 by use of the ultrasonic flip-chip mounting method, for example. The optical semiconductor element 8 may be a light-emitting element or light-receiving element and can utilize a surface emitting laser (Vertical Cavity Surface Emitting Laser [VCSEL]), for example, as the light-emitting element and utilize a PIN photodiode, for example, as the light-receiving element. The optical semiconductor element 8 has light-emitting regions or light-receiving regions and electrodes provided on the surface opposite to the optical semiconductor element mounting surface 4. The electrodes of the optical semiconductor element 8 are arranged at the same intervals (125 μm in this example) as those of the electrical interconnections 5 provided on the holding member main bodies 1 and 101 and are electrically connected to the electrical interconnections 5 of the holding member main bodies 1 and 101 via bumps such as Au stud bumps, Au plating bumps, solder bumps and the like, for example.

The light-emitting regions or light-receiving regions (for example, the diameter of 10 to 100 μm) of the optical semiconductor element 8 are arranged at the same intervals (250 μm in this example) as those of the openings 3 of the holding member main bodies 1 and 101. The optical semiconductor element 8 is mounted on the optical semiconductor element mounting surface 4 to arrange the light-emitting regions or light-receiving regions thereof in positions on the openings 3 of the holding holes 2 and can be optically coupled with the optical transmission lines 7 inserted in the holding holes 2.

The optical coupling material 9 optically couples the light-emitting region or light-receiving region of the optical semiconductor element 8 with the optical transmission line 7 in an optical module in which the optical semiconductor element 8 is mounted on the electrical interconnections 5 of the holding member main bodies 1 and 101 and the optical transmission lines 7 are held in the holding holes 2. Further, the optical coupling material 9 protects and reinforces the electrical connecting portion between the optical semiconductor element 8 and the electrical interconnection 5 and fixes the optical semiconductor element 8. It is desirable for the optical coupling material 9 to exhibit permeability in at least optical signal wavelength used and set the refractive index of the optical coupling material 9 substantially equal to that of the core of the optical transmission line 7.

The optical coupling material 9 is desirably formed of a material that has a thermosetting property or ultraviolet-curable property and is excellent in the stress reducing property as an under-fill function. As the optical coupling material 9, for example, epoxy resin or silicon resin can be used. Further, in this embodiment, an example in which optical coupling and electrical connection protection are attained only by means of the optical coupling material 9 is shown, but the optical coupling material 9 may be used for optical coupling and resin different from the optical coupling material 9 may be used for electrical connection protection.

In the manufacturing process of the optical module using the optical transmission line holding member shown in FIGS. 2A and 2B, the optical transmission lines 7 are inserted into the holding holes 2 from the openings 11 after the optical coupling materials 9 are coated on the other-side openings 11 of the holding holes 2 of the holding member main bodies 1 and 101 having the optical semiconductor element 8 mounted thereon. The optical coupling material 9 pushed by the optical transmission line 7 overflows from the opening 3 of the holding member body 1 or 101 and reaches the light-emitting region or light-receiving region of the optical semiconductor element 8. Then the optical coupling material 9 flows out to the exterior via a gap between the optical semiconductor element mounting surface 4 of the holding member body 1 and the optical semiconductor element 8.

At this time, bubbles 10 (for example, the diameter of 10 to 100 μm) involved in the resin manufacturing process, remaining in the holding hole 2 at the coating time of the optical coupling material 9 or occurring at the heating time are present in the optical coupling material 9. The size of the bubble 10 is so large as not to be neglected in comparison with the size (in this example, the diameter of the light-emitting region is 10 to 100 μm) of the light-emitting region or light-receiving region formed in the optical semiconductor element 8. Therefore, if the bubbles 10 remain in the optical coupling portion between the optical semiconductor element 8 and the optical transmission line 7, light is scattered on the interface between the bubbles 10 and the optical coupling material 9 to greatly reduce the optical coupling efficiency. In this case, for example, a signal with noise increases an error rate and light is reflected on the interface between the bubbles 10 and the optical coupling material 9 to become return light. Then, there occurs a problem that light emission of the optical semiconductor element 8 used as the light-emitting element becomes unstable and the reliability of optical coupling is degraded.

The gap between the optical semiconductor element 8 and the optical semiconductor element mounting surface 4 used as the flow-out passage of the optical coupling material 9 pushed out from the opening 3 of the holding hole 2 is 3 to 10 μm, for example.

Therefore, when the holding member body 101 as shown in FIG. 2B is used, the size of bubbles 10 is small in comparison with the distance between the optical semiconductor element mounting surface 4 and the optical semiconductor element 8. Therefore, bubbles 10 are difficult to be pushed in between the optical semiconductor element mounting surface 4 and the optical semiconductor element 8 and the bubbles 10 tend to remain.

On the other hand, when the holding member body 1 of this embodiment as shown in FIG. 2A is used, the distance between the optical semiconductor element 8 and the optical semiconductor element mounting surface 4 through which the optical coupling material 9 pushed out from the opening 3 passes can be partially increased since the groove 6 is provided in the peripheral portion of the opening 3. Therefore, since bubbles 10 present in the optical coupling material 9 pass through the groove 6 and flow out to the exterior, the bubbles can be prevented from remaining in the optical coupling portion between the optical semiconductor element 8 and the optical transmission line 7. As a result, the reliability of optical coupling between the optical semiconductor element 8 and the optical transmission line 7 can be enhanced and unstable signal transmission described before can be prevented.

Thus, in the optical transmission line holding member of this embodiment, bubbles 10 larger than the distance between the optical semiconductor element 8 and the optical semiconductor element mounting surface 4 can be discharged to the exterior by providing the grooves 6 in the optical semiconductor element mounting surface 4 of the holding member body 1. Therefore, bubbles 10 can be prevented from remaining in the optical coupling portion between the optical semiconductor element 8 and the optical transmission line 7 and the reliability of optical coupling between the optical semiconductor element 8 and the optical transmission line 7 in the optical module using the optical transmission line holding member can be enhanced.

If the grooves 6 reach the peripheral portion of the optical semiconductor element mounting surface 4 of the holding member body 1, bubbles 10 can be discharged to the exterior of the body 1 and if the grooves 6 reach portions near the periphery, light emission and light reception of the optical semiconductor element 8 are not obstructed and the reliability of optical coupling is not degraded.

It is desirable to set the cross-sectional area (the area of a surface perpendicular to the direction in which the optical coupling material 9 flows) of the groove 6 greater than or equal to the area of the opening 3 of the holding hole 2. This is attained by, for example, forming a rectangular-shaped groove of width 150 μm and depth 100 μm. As described before, in a step of inserting the optical transmission line 7 into the holding member body 1, one of the causes of leaving bubbles 10 in the optical coupling portion between the optical semiconductor element 8 and the optical transmission line 7 is that the flow rate of the optical coupling material 9 that flows out from the opening 3 is low. This is because the flow rate is limited with the opening 3 set as a boundary since the flow amount of the optical coupling material 9 flowing from the opening 3 to the exterior is small in comparison with the flow amount of the optical coupling material 9 flowing through the holding hole 2. In order to solve the above problem, the flow amount of the optical coupling material 9 flowing from the opening 3 to the exterior may be set larger than the flow amount thereof flowing through the holding hole 2. This is realized by setting the cross-sectional area of the groove 6 greater than or equal to the cross-sectional area of the opening 3.

When the groove 6 extending from the opening 3 is divided into a plurality of branch grooves, the same effect can be attained if the total sum of the cross-sectional areas of the branch grooves is greater than or equal to the cross-sectional area of the opening 3.

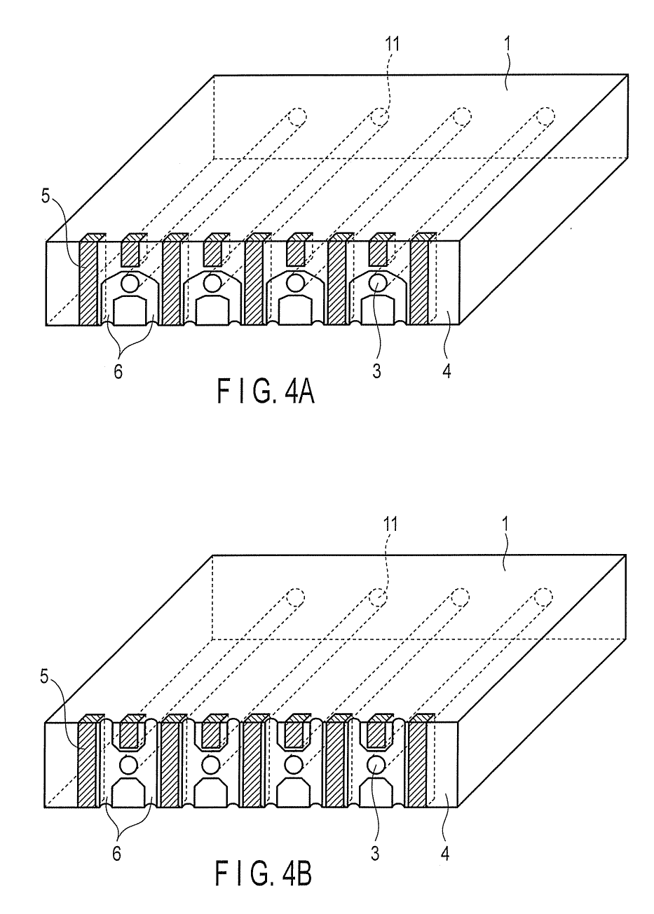

FIGS. 3, 4A and 4B show modifications of the grooves 6 provided in the holding member body 1. Portions that are the same as those of FIGS. 1A and 1B are denoted by the same numbers and detailed explanation thereof is omitted.

As shown in FIG. 3, electrical interconnections 5 are provided on the lower side in the drawing of the optical semiconductor element mounting surface 4 and the grooves 6 are provided on the right and left sides of the electrical interconnections 5 to avoid the electrical interconnections 5.

When the cross-sectional surfaces of the electrical interconnections 5 exposed to the side surface of the holding member body 1 are used as electrodes for electrical connection with the exterior, a problem that the electrical interconnections 5 are contaminated due to attachment of an optical coupling material 9 flowing out in an insertion step of the optical transmission line 7 may occur in the holding member body 101 having no grooves formed therein. Therefore, the electrical interconnections 5 can be prevented from being contaminated due to attachment of the optical coupling material 9 flowing out from the opening 3 in the optical transmission line insertion step described before by forming the grooves 6 only on the lower side in the drawing of the optical semiconductor element mounting surface 4 as shown in FIG. 4A. The formation position of the grooves 6 is not limited to the lower side of the drawing and can be properly changed according to portions of the electrical interconnections 5 that are desirably protected from being contaminated by the optical coupling material 9. Further, as shown in FIG. 4B, the grooves 6 may be formed on both of the upper and lower sides of the drawing to separately flow the optical coupling material on the upper and lower sides of the optical semiconductor element mounting surface 4 in the optical module forming process. In the structure shown in FIG. 3, the grooves 6 may be formed on both of the upper and lower sides in the drawing.

In (Jp-A 2008-299092 (KOKAI)), two convex portions are formed to sandwich a plurality of holding holes on the optical semiconductor element mounting surface of the holding member body to release optical coupling materials flowing out from the holding holes through a gap between the convex portions. However, in this case, there occurs no problem in the holding hole on the outermost side, but an optical coupling material flowing out from the hole passes over the opening of the other holding hole with respect to the holding hole lying inside the above holding hole. Therefore, it is undesirable in discharging the bubbles 10 to the exterior. In this embodiment, since the grooves 6 are formed in a direction different from that of the adjacent holding holes 2, optical coupling materials flowing out from the holding holes 2 can be rapidly discharged to the exterior.

Further, in (Jp-A 2008-299092 (KOKAI)), a different process for forming the convex portions on the optical semiconductor element mounting surface is necessary. In this embodiment, since the holding member body having the grooves formed therein can be formed by an injection-molding process using a mold, it is unnecessary to perform a different process for groove formation. Therefore, this embodiment can be contributed to simplification of the manufacturing process and reduction in the manufacturing cost.

(Second Embodiment)

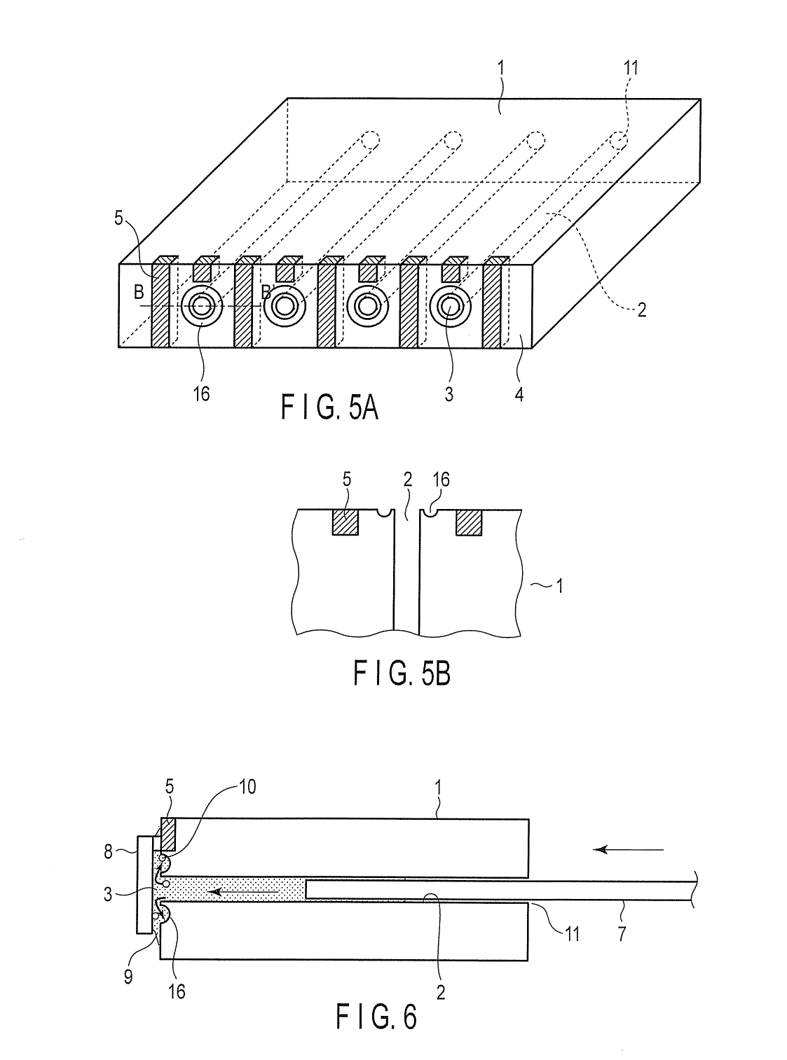

FIG. 5A is a perspective view of the optical transmission line holding member as viewed from the optical semiconductor element mounting surface side and FIG. 5B is a cross-sectional view taken along line B-B′ of FIG. 5A. Portions that are the same as those of FIGS. 1A and 1B are denoted by the same numbers and detailed explanation thereof is omitted.

In this embodiment, as shown in FIG. 5A, grooves 16 concentrically formed with one-side openings 3 of holding holes 2 are provided at preset distances from the respective openings 3. Thus, a gap between an optical semiconductor element 8 and an optical semiconductor element mounting surface 4 in a region surrounded between the peripheral portion of the opening 3 and the inner periphery of the groove 16 can be reduced. The groove 16 is not necessarily a truly circular ring but may be an elliptical ring.

In a process of inserting optical transmission lines 7 together with optical coupling materials 9 into the holding holes 2 of the holding member body 1 as described before, the optical coupling material 9 pushed out by means of the optical transmission line 7 and flowing out from the opening 3 passes through a region surrounded between the peripheral portion of the opening 3 and the inner periphery of the groove 16 and reaches the corresponding groove 16. Further, in order to uniformly flow out the optical coupling material 9 flowing out from the opening 3 in all directions, the groove 16 is concentrically formed with the one-side opening 3.

FIG. 6 illustrates a flow-out process of the optical coupling material 9 in a process of inserting the optical transmission line 7 together with the optical coupling material 9 into the holding hole 2 of the holding member body 1 and is a cross-sectional view of the holding member body 1. In this case, each groove 16 is a ring-form groove concentrically formed with the one-side opening 3 and provided at a preset distance from the opening 3.

In the first embodiment, the passage that permits the bubbles 10 larger than the distance between the optical semiconductor element 8 and the optical semiconductor element mounting surface 4 to flow out to the exterior is securely attained by providing the groove 6 connected to the opening 3 and the bubbles 10 are suppressed from remaining. On the other hand, in the present embodiment, flow-out of the bubbles 10 is accelerated and the bubbles 10 are suppressed from remaining by partially increasing the flow rate of resin lying near the light-emitting region or light-receiving region of the optical semiconductor element 8 by using the groove 16 concentrically formed with the opening 3.

As shown in FIG. 6, in the optical transmission line holding member in which the grooves 16 concentrically formed with the one-side openings 3 are provided at preset distances from the respective openings 3, the distance between the optical semiconductor element 8 and the optical semiconductor element mounting surface 4 is short in the region surrounded between the peripheral portion of the opening 3 and the inner periphery of the groove 16 and is long in a portion of the groove 16 that surrounds the above region. Therefore, the flow rate of the optical coupling material 9 can be locally increased only in the optical coupling portion between the optical transmission line 7 and the light-emitting region or light-receiving region of the optical semiconductor element 8 in which remaining of the bubbles 10 is desired to be suppressed in comparison with the holding member body 1 in which the grooves 6 are connected to the respective openings 3 as shown in FIG. 1A. As a result, the bubbles 10 present in the optical coupling material 9 tend to be pushed out together with the optical coupling material 9 and can be prevented from remaining in the optical coupling portion between the optical semiconductor element 8 and the optical transmission line 7. Therefore, unstable signal transmission described before can be prevented and the reliability of optical coupling between the optical semiconductor element 8 and the optical transmission line 7 can be enhanced.

Thus, in the optical transmission line holding member of this embodiment, the flow rate of the optical coupling material 9 can be increased by providing the grooves 16 concentrically formed with the one-side openings 3 at preset distances from the peripheral portions of the respective openings 3 of the holding holes 2 in the optical semiconductor element mounting surface 4 of the holding member body 1. As a result, bubbles 10 present in the optical coupling material 9 tend to be pushed out together with the optical coupling material 9 can be prevented from remaining in the optical coupling portion between the optical semiconductor element 8 and the optical transmission line 7 and the reliability of optical coupling between the optical semiconductor element 8 and the optical transmission line 7 can be enhanced in the optical module using the optical transmission line holding member.

In the region surrounded between the peripheral portion of the opening 3 and the inner periphery of the groove 16, the distance between the optical semiconductor element 8 and the optical semiconductor element mounting surface 4 is smaller in comparison with the bubble 10. Therefore, in order to permit the bubbles 10 to pass through between the optical semiconductor element 8 and the optical semiconductor element mounting surface 4, it is desirable to set the difference between the radius of the opening 3 and the inner peripheral diameter of the groove 16 smaller than the diameter of the bubble 10, for example, to 1 to 5 μm.

FIGS. 7A and 7B shows modifications of the grooves 16 shown in FIGS. 5A and 5B. Portions that are the same as those of FIGS. 1A and 1B are denoted by the same numbers and detailed explanation thereof is omitted. In FIGS. 7A and 7B, 16a denotes concentric grooves and 16b denotes different grooves connected to the concentric grooves 16a. One end of each groove 16a reaches the peripheral portion of the optical semiconductor element mounting surface 4 of the holding member body 1.

As shown in FIG. 7A, the different grooves 16b may be connected to the concentric grooves 16a. The different groove 16b is not limited to a single straight groove as shown in FIG. 7A, and can be formed in a desired form and a plurality of grooves may be provided. Further, as shown in FIG. 7B, grooves 16 formed by connecting the grooves shown in FIG. 4B to the respective concentric grooves may be provided.

(Third Embodiment)

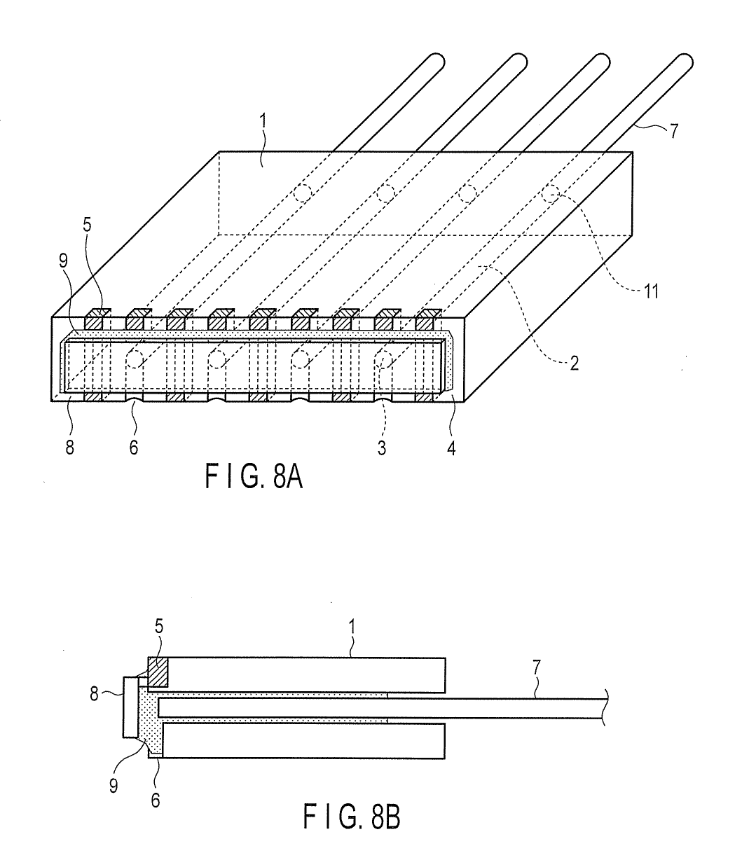

FIG. 8A is a perspective view and FIG. 8B being a cross-sectional view taken along a holding hole 2 of the optical module of FIG. 8A. Portions that are the same as those of FIG. 1 and FIG. 2 are denoted by the same symbols and detailed explanation thereof is omitted.

The optical module in this embodiment includes an optical transmission line holding member explained in FIGS. 1A and 1B, and optical transmission lines 7, optical semiconductor element 8 and optical coupling materials 9 explained in FIGS. 2A and 2B.

The optical semiconductor element 8 has a surface on which light-emitting regions or light-receiving regions and electrodes are provided. The electrodes of the optical semiconductor element 8 are electrically connected to electrical interconnections 5 via bumps to set the light-emitting regions or light-receiving regions of the optical semiconductor element 8 at central portions of openings 3 of a holding member body 1. The optical transmission line 7 is inserted in the holding hole 2 of the holding member body 1 and mechanically supported while the front end thereof inserted in the holding hole 2 is set to face the light-emitting region or light-receiving region of the optical semiconductor element 8. The optical coupling material 9 is filled between the optical semiconductor element 8 and the optical transmission line 7 and in the internal portion of the holding hole 2 and plays a role of optically coupling the optical semiconductor element 8 with the optical transmission line 7, protecting the electrical connecting portion between the electrode of the optical semiconductor element 8 and the electrical interconnection 5 and fixing the optical semiconductor element 8 and optical transmission line 7.

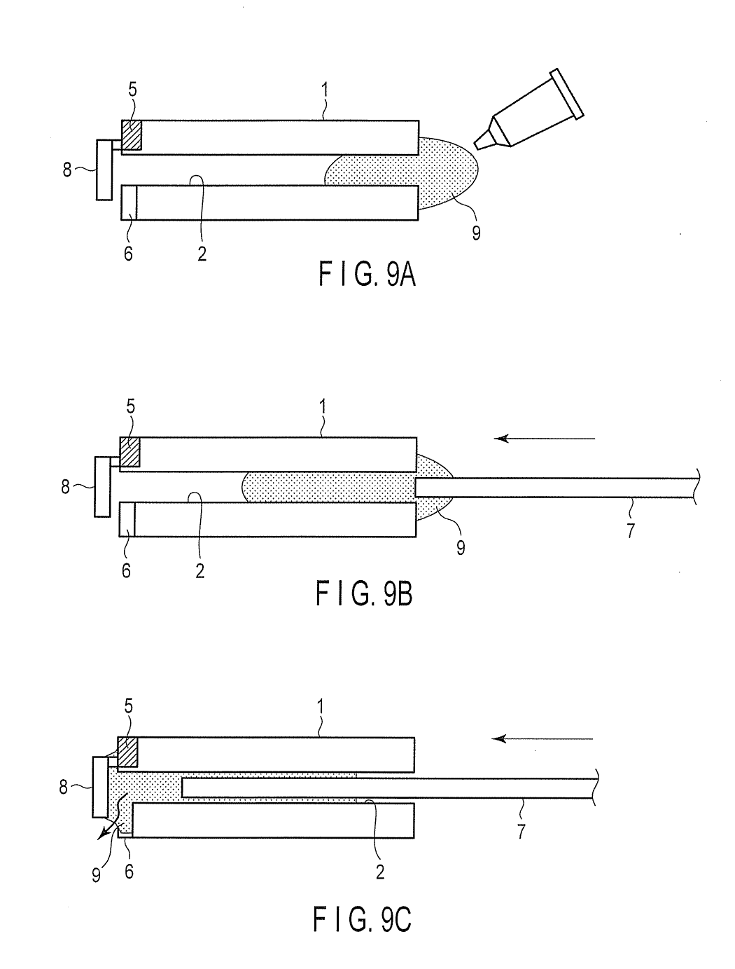

FIG. 9A shows the coating step of the optical coupling material 9, FIG. 9B shows the state immediately before the insertion step of the optical transmission line 7 and FIG. 9C shows the state in the course of the insertion step of the optical transmission line 7. Portions that are the same as those of FIGS. 8A and 8B are denoted by the same symbols and detailed explanation thereof is omitted.

The optical module manufacturing process includes a step of mounting the optical semiconductor element 8 on the holding member body 1, a step of coating the optical coupling material 9 to an other-side opening 11 of the holding member body 1 after the above step and a step of inserting the optical transmission line 7 into the holding hole 2 of the holding member body 1 to push out the optical coupling material 9 from a one-side opening 3 after the above step.

In the following description, the coating step of the optical coupling material 9 and the insertion step of the optical transmission line 7 related to grooves 6 formed in the holding member body 1 are explained.

As shown in FIG. 9A, in the coating step of the optical coupling material 9, for example, an optical coupling material 9 is coated on a portion of the other-side opening 11 of the holding member body 1 in which the optical semiconductor element 8 is mounted on the electrical interconnections 5 by an ultrasonic flip-chip mounting method. For example, if a resin material is used as the optical coupling material 9, the coating step is performed by use of a dispenser, for example. In the coating step of the optical coupling material 9, if the material is coated while being separately poured plural times, there occurs a possibility that bubbles 10 are introduced into between the optical coupling material 9 first coated and the optical coupling material 9 additionally coated later. Therefore, it is desirable to avoid coating the optical coupling material 9 while additionally pouring the optical coupling material 9. Further, the optical coupling material 9 to be coated is coated to completely cover the other-side opening 11 so as to permit air in the holding hole 2 to be extracted only from the one-side opening 3 at the insertion time of the optical transmission line 7. Additionally, since it is necessary for the optical coupling material 9 to be pushed into the holding hole 2 by means of the optical transmission line 7, flow out from the opening 3 and be filled between the optical transmission line 7 and the light-emitting region or light-receiving region of the optical semiconductor element 8, a sufficiently large amount of optical coupling material is coated.

Next, in the insertion step of the optical transmission line 7 shown in FIGS. 9B and 9C, the optical transmission line 7 is inserted into the holding hole 2 from the other-side opening 11 and pushed in until it reaches the one-side opening 3. By thus pushing the optical transmission line 7, the optical transmission line 7 pushes the optical coupling material 9 coated on the opening 11 into the holding hole 2. As a result, the optical coupling material 9 is pushed out from the opening 3 and filled in between the optical semiconductor element 8 and the optical semiconductor element mounting surface 4 and in the internal portion of the holding hole 2. In the insertion step of the optical transmission line 7, it is preferable to insert the optical transmission line at a preset speed until insertion is completed in order to prevent bubbles 10 from being involved in the internal portion of the optical coupling material 9. In this step, the groove 6 of the holding member body 1 acts as a passage through which the optical coupling material 9 pushed out from the opening 3 by means of the optical transmission line 7 flows out near the opening 3. Therefore, the flow rate of the optical coupling material 9 becomes higher in comparison with the case wherein no grooves 6 are provided, bubbles 10 do not remain between the optical transmission line 7 and the light-emitting region or light-receiving region of the optical semiconductor element 8 and an optical module having an excellent optical coupling property can be manufactured.

The optical coupling material 9 is cured after the optical transmission line 7 is inserted to a present position. A necessary process is performed according to the type of the optical coupling material 9 to cure the optical coupling material 9. For example, if the optical coupling material 9 is a thermosetting resin, a heating process is performed to cure the same and if the optical coupling material 9 is an ultraviolet-curable resin, an ultraviolet application process is performed to cure the same. In the case of the thermosetting resin, it is desirable to use thermosetting resin that is cured in a temperature range in which the characteristic of the optical semiconductor element 8 is not degraded.

As described above, in the optical module manufactured by using the optical transmission line holding member having the holding holes 6 formed therein, the optical coupling materials 9 pushed out from the one-side openings 3 by means of the optical transmission lines 7 are discharged from the grooves 6 in the manufacturing process thereof to increase the flow rate of the optical coupling materials 9. Therefore, bubbles 10 do not remain between the optical transmission line 7 and the light-emitting region or light-receiving region of the optical semiconductor element 8 and an optical module having an excellent optical coupling property can be manufactured.

(Modification)

This invention is not limited to the embodiments described above. In the embodiments, the shape of the holding member body is a rectangular form, but the shape is not limited to this form and any type of form can be used. Further, the grooves each of which connects the one-side opening of the holding hole to the peripheral portion of the optical semiconductor element mounting surface are not continuously formed with a plurality of holding holes and are desired to be independently provided for the respective holes. Further, the size and the number of holes provided in the holding member body can be adequately changed according to the specification.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical transmission line holding member comprising:
a holding member body including an optical semiconductor element mounting surface and an opposite surface thereof and configured to hold optical transmission lines and mount an optical semiconductor element,
a plurality of holding holes formed to penetrate between the optical semiconductor element mounting surface of the holding member body and the opposite surface thereof, the holding holes having, an opening on the optical semiconductor element mounting surface side, the optical transmission lines being inserted in the holding holes to be held therein,
a plurality of electrical interconnections provided on a part of the optical semiconductor element mounting surface and electrically connected to the optical semiconductor element, and
a plurality of grooves provided adjacent to the openings of the holding holes in a part of a region of the optical semiconductor element mounting surface except a region in which the electrical interconnections.

2. The member of claim 1, wherein the grooves are provided to connect a peripheral portion of the optical semiconductor element mounting surface to the opening of the holding hole.

3. The member of claim 2, wherein a cross-sectional area of the groove taken along a direction perpendicular to an extending direction of the groove is not smaller than a cross-sectional area of the opening taken along a direction perpendicular to an extending direction of the holding hole.

4. The member of claim 1, wherein the groove is a ring-form groove along a periphery of the opening of the holding hole.

5. The member of claim 1, wherein the groove includes a first groove of a ring form along a periphery of the opening of the holding hole and a second groove connecting the first groove to a peripheral portion of the optical semiconductor element mounting surface.

6. The member of claim 1, wherein the electrical interconnection is formed by embedding lead frame in the optical semiconductor element mounting surface of the holding member body.

7. The member of claim 6, wherein the electrical interconnection permit surface portion of the lead frame to be exposed to the optical semiconductor element mounting surface and permit end-face portion of the lead frame to be exposed to side surfaces of the holding member body adjacent to the optical semiconductor element mounting surface.

8. An optical transmission line holding member comprising:
a holding member body configured to hold optical transmission lines and mounting an optical semiconductor element, the holding member body having a plurality of holding holes formed therein to penetrate between an optical semiconductor element mounting surface on which the optical semiconductor element is mounted and an opposite surface thereof and a plurality of grooves formed adjacent to openings of the holding holes in a part of the optical semiconductor element mounting surface of the holding member, and
a plurality of electrical interconnections provided on a part of the optical semiconductor element mounting surface and electrically connected to the optical semiconductor element.

9. The member of claim 8, wherein the groove is provided in a part of the optical semiconductor element mounting surface except a region in which the electrical interconnections are formed.

10. The member of claim 8, wherein the groove is provided to connect a peripheral portion of the optical semiconductor element mounting surface to the opening of the holding hole.

11. The member of claim 10, wherein a cross-sectional area of the groove taken along a direction perpendicular to an extending direction of the groove is not smaller than a cross-sectional area of the opening taken along a direction perpendicular to an extending direction of the holding hole.

12. The member of claim 8, wherein the groove is a ring-form groove along a periphery of the opening of the holding hole.

13. The member of claim 8, wherein the groove includes a first groove of a ring form along a periphery of the opening of the holding hole and a second groove configured to connect the first groove to a peripheral portion of the optical semiconductor element mounting surface.

14. The member of claim 8, wherein the electrical interconnection is formed by embedding lead frame in the optical semiconductor element mounting surface of the holding member body.

15. The member of claim 14, wherein the electrical interconnection permit surface portion of the lead frame to be exposed to the optical semiconductor element mounting surface and permit end-face portion of the lead frame to be exposed to side surfaces of the holding member body adjacent to the optical semiconductor element mounting surface.

16. An optical module comprising:
optical transmission lines,
an optical semiconductor element,
a holding member in which a plurality of holding holes holding the optical transmission lines are formed to penetrate between an optical semiconductor element mounting surface having the optical semiconductor element mounted thereon and an opposite surface thereof, the holding member having a plurality of electrical interconnections provided on a part of the optical semiconductor element mounting surface and electrically connected to the optical semiconductor element and a plurality of grooves formed therein adjacent to openings of the holding holes in a part of a region of the optical semiconductor element mounting surface except a region of the electrical interconnections being provided, and
optical coupling materials filled between the optical transmission lines and the optical semiconductor element to optically couple the optical transmission lines to the optical semiconductor element,

17. The module of claim 16, wherein the groove is formed to connect a peripheral portion of the optical semiconductor element mounting surface to the opening of the holding hole.

18. The module of claim 16, wherein the groove is a ring-form groove along a periphery of the opening of the holding hole.

19. The module of claim 16, wherein the groove includes a first groove of a ring form along a periphery of the opening of the holding hole and a second groove connecting the first groove to a peripheral portion of the optical semiconductor element mounting surface.

20. The module of claim 16, wherein the electrical interconnection is formed by embedding lead frame in the optical semiconductor element mounting surface of the holding member body.
